(19) United States
(12) Patent Application Publication
(10) Pub. No.: US 2008/0241445 A1
(43) Pub. Date: Oct. 2, 2008

(54) Flower Vase and Blank for the Production Thereof

(75) Inventors: Rui Medeiros Santos, Rotterdam (NL); Irazya Korver, Den Haag (NL); Janneke Verhagen, Eindhoven (NL)

Correspondence Address: YOUNG & THOMPSON, 209 Madison Street, Suite 500, ALEXANDRIA, VA, 22314, US

(73) Assignee: DECOMMANDITAIRE VENNOOTSCHAP BIN 2004, Delft (NL)

(21) Appl. No.: 12/066,157

(22) PCT Filed: Sep. 7, 2006
(86) PCT No.: PCT/NL2006/050225

§ 371 Date: May 14, 2008

(30) Foreign Application Priority Data
Sep. 7, 2005 (NL) 1029899

(51) Int. Cl. B32B 1/08

(52) U.S. Cl. 428/34.1

(57) ABSTRACT

Flower vase made of a watertight, cardboard-like material. Starting from a blank, after fold lines suitably applied have been introduced, a vase is obtained, which is watertight without glue or sealing techniques. In particular it is proposed to design the folding structure such that there are elastic material flaps in the middle of the vase for accommodating a bouquet of flowers closely fitting therein. Because of the folding inwards, a stiff outside of the vase is created. Optional carrying handles, such as cords, can be applied such that this inward-moving effect for retaining a bunch of flowers is reinforced. A vase of this type can be provided with any desired printing and can have any desired dimensions.

The present invention relates to a flower vase according to the preamble of claim 1.

A flower vase of this type is known from JP 7277317. This describes a flower vase to be folded from a single blank section. The material used is corrugated cardboard laminated on one side.

In this way it is possible to provide a vase in a single operation, starting from a single blank and applying suitable fold lines. Moreover, it is possible after/during folding of the blank to put the vase into a flat state, in which it can be transported in a space-saving manner.

In the case of folding staring from a blank there is the problem of material “being left over”. In the Japanese publication a flower vase is provided which is substantially square, the left-over material being folded horizontally on the outside of one of the sides and being fastened thereto with the fastening means, such as staples, for a carrying handle.

This results in a flower vase which from certain sides has an unfinished appearance, owing to the folded material sticking out from it.

Moreover, a flower vase of this type has the disadvantage that flowers placed therein are not attractively distributed evenly over the surface of the vase. They are always inclined to be moved in one direction, as is apparent from the drawings in this publication.

From American patent publication 5.005.760 a flower vase is known consisting of a folded flat part. The fold sections forming the side wall extend from a rectangular-shaped base and can be pressed together like a concertina with a cord. By increasing the length of the cord, concertina-like sections can be folded out and a vase can be obtained.

Because of the space taken up in the folded state, it is not possible to supply a vase of this type efficiently to sales outlets. On the other hand, the folding, starting from the blank, is so complicated that it cannot easily be done at sales outlets for the flowers.

It is the aim of the present invention to avoid these disadvantages.

This aim is realised with a flower vase with the features of claim 1. By making the base foldable, it is possible to supply the flower vase to sales outlets in pre-folded state in a particularly compact way, simple unfolding alone being sufficient to produce a flower vase.

According to the present invention the material is folded such that “excess” material extends inwards and is therefore no longer visible to the user of the vase. Moreover, this gives rise to the possibility of conveying a bunch of flowers such that it is always as far as possible arranged round the centre of the vase.

This effect can be further promoted if, according to an advantageous embodiment of the invention, the end wall flaps taper from the base section to the top of the vase towards the centre of the vase. In this way gripping of a bunch of flowers takes place near the top of the vase. This engagement is resilient because of the folds made in the end wall flaps.

This effect is further promoted by applying further fold lines in the auxiliary side wall sections, so each auxiliary side wall section is divided into two subside wall sections. This gives rise to a concertina-like structure which extends from the outer limitation of the vase to the interior thereof.

According to a further advantageous embodiment of the invention except from the main side wall sections the outer limitation of the vase is formed by the first sections of the end wall sections. More particularly they are fastened to one another near the top ends by gluing or stapling. Folding out from the transport position into the final end position is made even easier by the presence of these fastening points. At these fastening points a pivoting movement of the various wall sections in respect of one another is possible.

Moreover, the first sections of the end wall sections are provided with fastening means for a handle. One example is making openings through which a carrying cord can extend. This promotes a movement of the first sections going further towards one another.

According to a further advantageous embodiment of the invention the base section is embodied as substantially rectangular, and more particularly square, and there are always triangular sections near the end wall sections. These preferably extend in the folded position of the vase slightly outwards from the base section and according to a further advantageous embodiment are in the same plane as the first sections of the end wall sections.

The above-described further fold line for limiting the sub-side wall sections extends from the fold line for limiting two sub-side wall sections made between a main side wall and an end wall. However, they extend more particularly at a distance a from the vertex of the base section concerned.

After the first folding, the above-described vase can be put into a flattened state by folding the base part along a main fold line. When it is pressed out, a stable situation arises, creating a stable vase. This stable situation is of course promoted by the weight of the flowers present therein and possible water present.

The invention also relates to a blank from which the above-described flower vase can be folded.

The invention will be explained in more detail below with reference to an illustrative example shown in the drawings, wherein

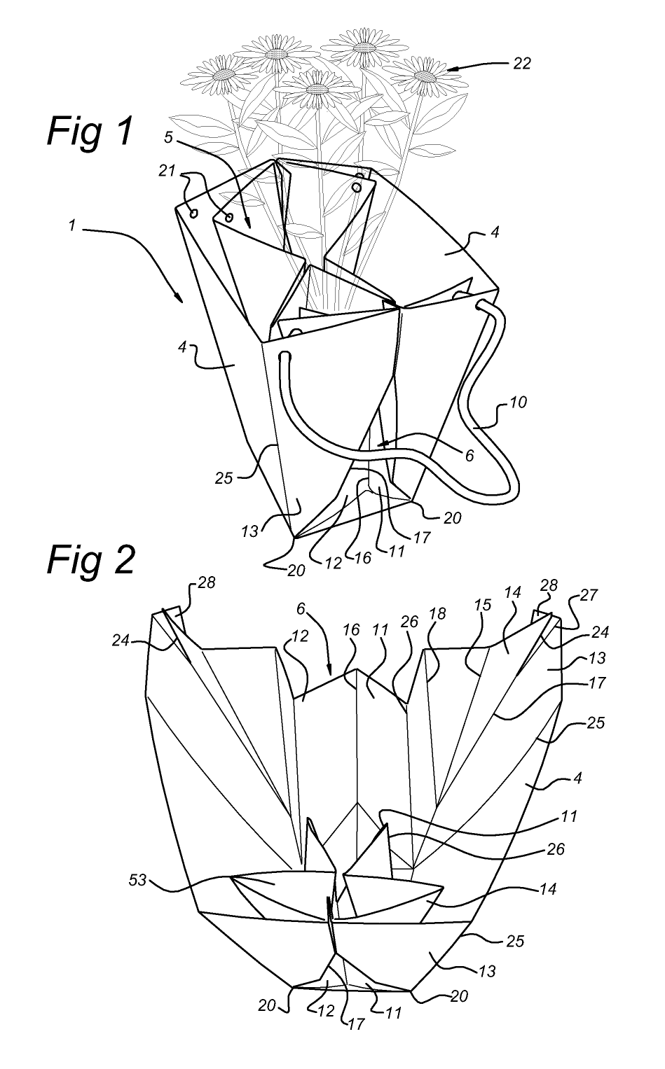

FIG. 1 illustrates the vase according to the invention in folded state in perspective;

FIG. 2 illustrates the vase according to the invention partially folded open;

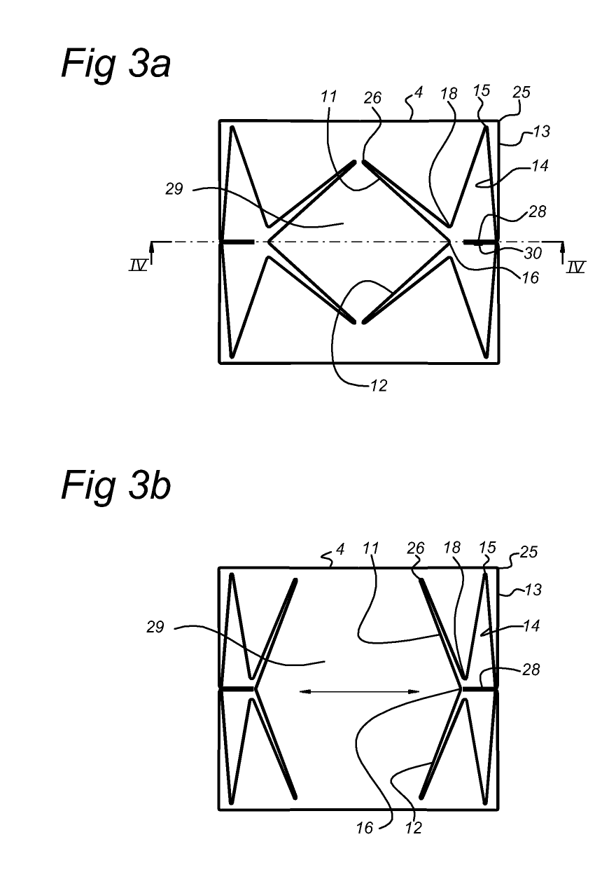

FIGS. 3a, b illustrate in top view various positions of the interior of the vase;

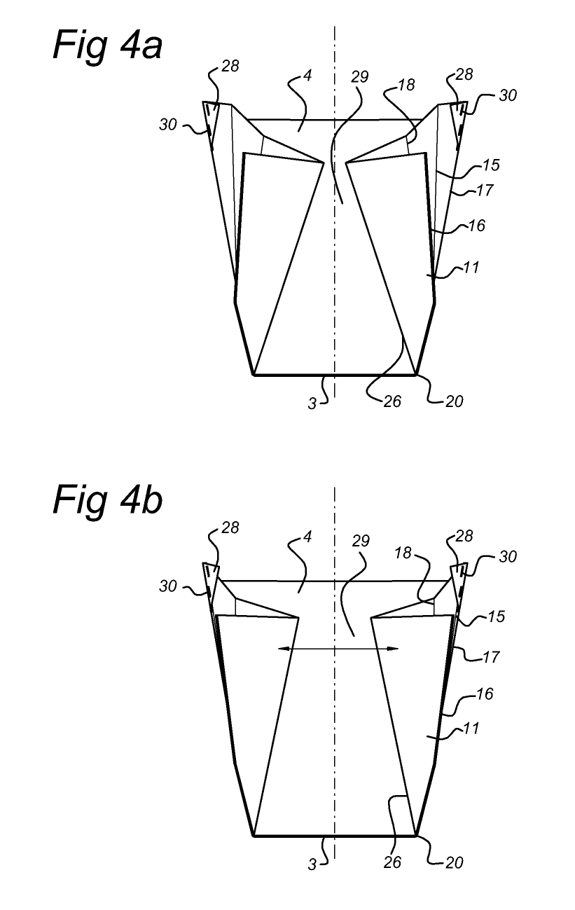

FIGS. 4a, b illustrate in cross-section various positions of the interior of the vase;

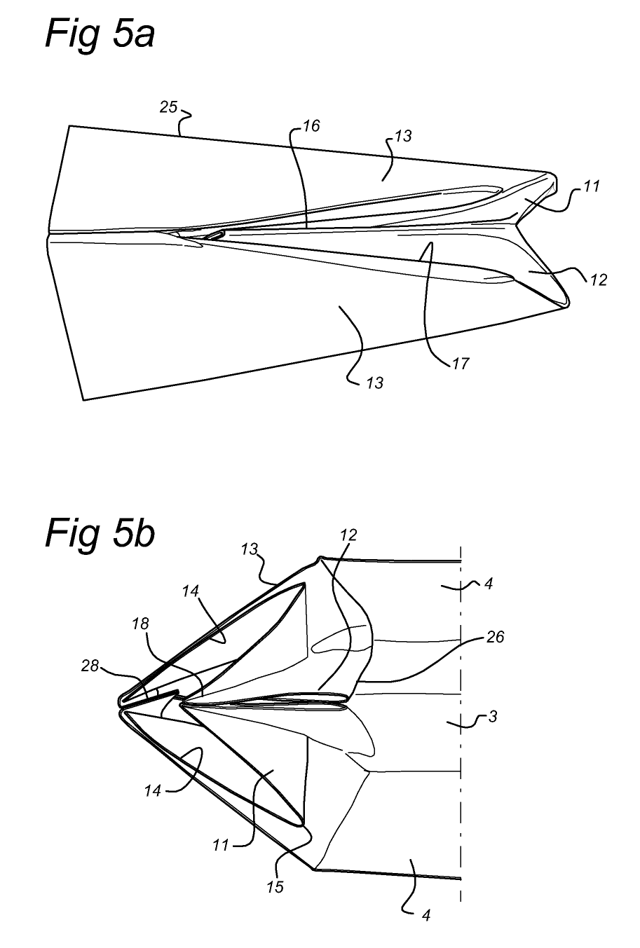

FIG. 5a illustrates in perspective laterally the flower vase in transport position in the folded-in position;

FIG. 5b illustrates a top view thereof;

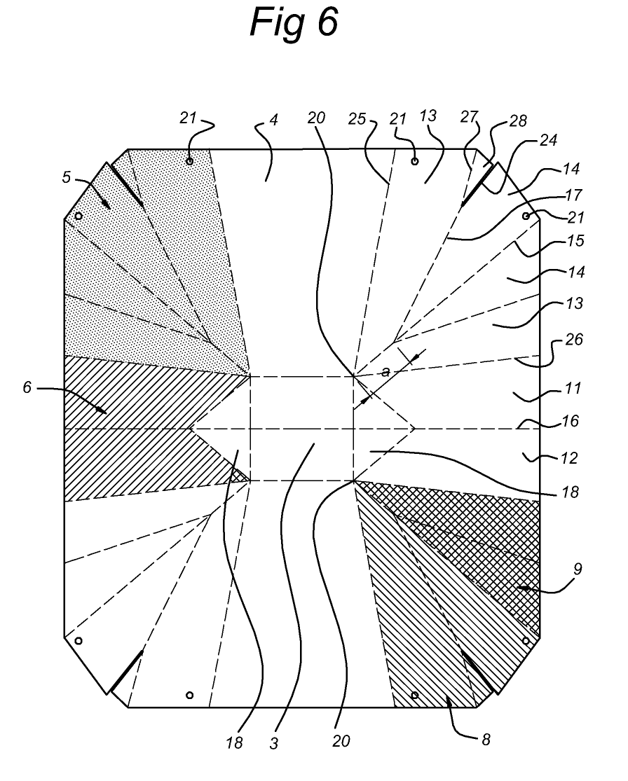

FIG. 6 illustrates a blank from which the vase according to the present invention is folded.

FIG. 1 shows a vase 1 for a bouquet of flowers 22. It must be understood that a plant or similar can also be transported therewith, instead of a bouquet of flowers. The vase 1 is provided with carrying handles 10, designed as a cord, arranged through openings 21. Other embodiments of the carrying handles are conceivable.

The vase 1 shown in FIG. 1 is obtained by folding a blank 2, as illustrated in FIG. 6. The blank can comprise any material and preferably consists of a paper or cardboard-like material provided with a water-resistant layer of plastic film. However, it is also possible to start from a rigid plastics material or similar.

The various sections of the vase will be discussed with reference to FIG. 6.

The vase consists of a base section 3 substantially embodied as rectangular and more particularly square.

Applied adjacent thereto are two main side wall sections 4. Triangular sections 18 are always applied adjacent to the other side. The vertices of the base section are indicated by 20.

The end wall sections of the vase are indicated by 6. By means of the main fold line 16, each end wall section 6 is divided into two end wall flaps 11 and 12.

Between the end wall sections 6 and main side wall sections 4 extend auxiliary side wall sections 5. Each auxiliary side wall section 5 is sub-divided into sub-side wall sections 8 and 9 by a fold line 15. As is apparent from FIG. 6, there is a fold line 17 which extends from the fold line 15, but begins at a distance a from the vertex 20. The fold line 17 ends at the later top end of the vase in a slit 24. It should be understood that this fold line 17 could also extend from the vertex 20.

Between the main side wall section 4 and the auxiliary side wall section 5 is a fold line 25. The limitation between auxiliary side wall section 5 and end wall section 6 is formed by fold line 26.

The fold line 17 divides each sub-side wall section 8 or 9 into a first section 13 and a second section 14. Both sections are provided with an opening 21, while the first section 13 is provided with a fold line 27.

Through the base section 3 extends a main fold line 16, which also extends through the triangular section and the end wall section 6.

Starting from the blank shown in FIG. 6, a vase can be obtained by erecting the various wall parts. This is effected such that the vase according to FIGS. 1 and 2 results. It is in this respect of importance that the outer limitation is formed by the main side wall sections 4, the directly adjacent first sections 13 and the triangular sections 18. The first sections 13, always adjacent to two opposite main side wall sections 4, are placed against one another and by the folding of lip 28 along fold line 27 and subsequent fastening to one another with a staple 30 a stable fastening can be provided. Instead of a staple, other connecting methods can also be applied, such as gluing or fusion welding of plastic films by making the blank from PE, for example, or a laminate of paper and plastics material. Moreover, a cord can be threaded through the openings 21. In this case various sections extend from the first sections 13 or fold line 7 to the interior of the vase. These further sections are formed by the second section 14 of the sub-side wall section 8. Adjacent thereto via fold line 15 is the second section 14 of the sub-side wall section 9. Adjacent to this is the first section 13 of the sub-side wall section 9 followed by an end wall flap 11 of inwardly folded end wall section 6.

As is apparent from FIGS. 1, 3 and 4, the limitation between the end wall flaps 11 and 12, i.e. the fold line 16, is positioned extending inwards at an angle. The same applies to fold line 26 between end wall section 6 and auxiliary side wall section 5. Because these zigzag flaps are designed opposite one another, a rectangular opening 29 arises for accommodating a bunch of flowers or other object therein. This rectangular opening can easily be enlarged, as is apparent from FIG. 3b or FIG. 4b respectively. This provides stable positioning of a bunch of flowers. It must be understood that certain cavities result in the flower vase, which extend from top to bottom and where no water settles. An example of such a cavity is space 53 in FIG. 2.

Because of the presence of the fold line 16 which extends through the base section 3 and moreover, promoted by the presence of staple 30, it is possible to provide an interim position of the flower vase, starting from the blank drawn in FIG. 6. This position is shown in FIGS. 5a and b. The flower vase is in this case substantially fully folded, but is subsequently or immediately put into a collapsed position, making the volume thereof particularly small. The first sections 13 and the sections situated behind them are in this case folded inwards round staple 30 by pivoting. By also folding the base double, a particularly compact entity results. So, in this way the flower vase can be distributed to a sales outlet and only one unfolding action, which is particularly simple and possible in one way only, needs to take place.

As is apparent from FIG. 1, the vase has a particularly attractive outward appearance without flaps or such sticking out from it.

Although the invention above has been described with reference to an advantageous embodiment, variants will clearly occur to those skilled in the state of the art. It is possible to apply the fold lines described above in other ways and/or to design them not purely as rectangular. Moreover, it is possible, by punching in an appropriate way, to provide the top of the vase with a wavy or other special character. These and further changes are within the scope of the appended claims. Moreover, it should be understood that protection is expressly requested for the subject matter of the subsequent claims not in combination with claim 1.

1. Flower vase comprising a folded blank comprising a base section (3) and two opposite main side wall sections (4), extending therefrom, wherein adjacent to each of the main side wall sections (4) an auxiliary side wall section (5) is provided, said auxiliary side wall sections (5) being connected to end wall sections (6), said end wall sections (6) or main side wall sections (4) being divided by a fold line (16) into end wall flaps (12), wherein each auxiliary side wall section (5) comprises a fold line (15) for dividing each auxiliary side wall section into two sub-side wall sections (8, 9), wherein said flower vase is folded such that said end wall sections or main side wall sections (4) with said fold line (16) thereof directed outwards extend into the interior of said vase (1), characterised in that the base section (3) has a fold line (16).

2. Flower vase according to claim 1, wherein said fold line (16) comprises the fold line in the end flaps.

3. Flower vase according to claim 1, wherein the end wall flaps (11, 12) are applied tapering from the base section (3) to the top of said vase towards the centre (19) of said vase.

4. Flower vase according to claim 1, wherein in the auxiliary side wall sections further fold lines (17, 18) are provided, which divide each sub-side wall section (8, 9) into a first section (13) and a second section (14).

5. Flower vase according to claim 4, wherein the outer limitation of the vase is formed by the first sections (13).

6. Flower vase according to claim 4, wherein adjacent first sections (13) are connected to one another near the top thereof.

7. Flower vase according to claim 5, wherein adjoining said base section (3), near said end wall section, is applied a triangular section (18) which extends sloping outwards from the base section (3).

8. Flower vase according to claim 5, wherein said triangular section (18) substantially lies in the same plane as said first sections (13).

9. Flower vase according to claim 1, wherein extending inwards in a zigzag from a main wall (4) in succession are applied:
a first section (13) and a second section (14) of a sub-side wall section (8);
a second section (14) and a first section (13) of the adjacent sub-side wall section (9) and an end flap (11).

10. Flower vase according to claim 4, wherein said further fold line (17) is attached extending from said fold line (15) at a distance (a) from a corner (20) of said base section (3).

11. Flower vase according to claim 1, wherein said first and second sections are provided with fastening means (21) for a handle.

12. Flower vase according to claim 1, wherein the end wall sections (16) are movable resiliently.

13. Blank for forming a flower vase comprising a base section (3) and two opposite main side wall sections (4) extending therefrom, wherein adjacent to each of the main side wall sections (4) there is always an auxiliary side wall section (5), said auxiliary side wall sections (5) being connected by end wall sections (6), said end wall sections (6) being divided into end wall flaps (12) by a fold line (16), wherein each auxiliary side wall section (5) comprises a fold line (15) for dividing each auxiliary side wall section into two sub-side wall sections (8, 9), wherein said base section (3) comprises base section halves folded towards one another according to a fold line (16).

14. Blank for making a flower vase according to claim 1.

15. Flower vase according to claim 1, wherein adjoining said base section (3), near said end wall section, is applied a triangular section (18) which extends sloping outwards from the base section (3).

16. Flower vase according to claim 2, wherein the end wall flaps (11, 12) are applied tapering from the base section (3) to the top of said vase towards the centre (19) of said vase.

17. Flower vase according to claim 5, wherein adjacent first sections (13) are connected to one another near the top thereof.
